(19) United States
(12) Patent Application Publication
(10) Pub. No.: US 2006/0202995 A1
(43) Pub. Date: Sep. 14, 2006

(54) Operation history displaying apparatus and method thereof

(75) Inventors: Takeshi Nagamine, Kanagawa (JP); Alejandro Jaimes, Kanagawa (JP); Kengo Omura, Kanawaga (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/218,646

(22) Filed: Sep. 6, 2005

(30) Foreign Application Priority Data
Mar. 10, 2005 (JP) 2005-068254

(51) Int. Cl. G06T 11/20

(52) U.S. Cl. 345/440

(57) ABSTRACT

There is provided an operation history display apparatus including a reproducing portion reproducing data according to a given operation mode, a timer counting an elapsed time from a start of an operation, and a retaining portion retaining information on a reproduction position in the data reproduced by the reproducing portion, an elapsed time from the start of the operation, and a current operation mode, as operation history information.

### BACKGROUND OF THE INVENTION

1. Field of the Invention

This invention relates to an operation history displaying apparatus, a method thereof and a program therefor.

2. Description of the Related Art

In search of a scene while playing data of moving images, a user often likes to watch the scene once again that has been watched before or skip the scene to the contrary. For example, a bookmark is used for facilitating the search. The bookmark facilitates an access by marking a voice message on a bookmarked point, as described in Japanese Patent Application Publication No. 2001-216334 (hereinafter, referred to as Document 1). In addition, on another conventional technique, something serving as a marker of a reproduction position is provided on an arbitrary reproduction position. An image data playing apparatus that utilizes the aforementioned marker has been proposed in Japanese Patent Application Publication No. 2000-48545 (hereinafter, referred to as Document 2). With the marker, it is possible to know at what point the multimedia data is being played and play the multimedia data from a desired point immediately. With respect to each of the above-mentioned two conventional techniques, the user is able to put a marker in the moving image so that the user can identify the scene later.

Another technique has been proposed for searching a moving image file that has been accessed before for a particular scene or frame promptly and surely. For example, the moving images are weighted after playing. At the time of watching the moving images later again, the moving images are displayed sequentially according to the weighting. Also, the reproduction position being displayed in chart facilitates understanding of the reproduction position of the last time, and supports for accessing the desired scene, as described in Japanese Patent Application Publication No. 5-54085 (hereinafter, referred to as Document 3).

According to Documents 1 and 2, it is possible to put the bookmark on the moving image data or the like. However, it is impossible to intuitively understand an operation history made by the user including the scene that has been accessed before or the scene that has been watched once.

Moreover, according to Document 3, it is possible to immediately grasp the reproduction position of the last time and access the desired scene. However, it is impossible to intuitively understand the operation history made by the user.

### SUMMARY OF THE INVENTION

The present invention has been made in view of the above circumstances and provides an operation history displaying apparatus, a method and a program thereof, with which the operation history can be understood intuitively.

According to one aspect of the present invention, there may be provided an operation history display apparatus including a reproducing portion reproducing data according to a given operation mode, a timer counting an elapsed time from a start of an operation, and a retaining portion retaining information on a reproduction position in the data reproduced by the reproducing portion, an elapsed time from the start of the operation, and a current operation mode, as operation history information.

According to another aspect of the present invention, there may be provided an operation history display method including reproducing data according to a given operation mode, counting an elapsed time from a start of an operation, retaining information on a reproduction position in the data reproduced by the reproducing portion, an elapsed time from the start of the operation, and a current operation mode, as operation history information, displaying an operation history of a user on the basis of the operation history information, and receiving an instruction to search the data from a user watching the operation history.

According to another aspect of the present invention, there may be provided an storage medium readable by a computer, the storage medium storing a program of instructions executable by the computer to perform a function for operation history display program, the function may include counting an elapsed time from a start of an operation when data is reproduced according to a given operation mode, retaining information on a reproduction position in the data reproduced by the reproducing portion, an elapsed time from the start of the operation, and a current operation mode, as operation history information, displaying an operation history of a user on the basis of the operation history information, and receiving an instruction to search the data from a user watching the operation history.

### BRIEF DESCRIPTION OF THE DRAWINGS

Embodiments of the present invention will be described in detail based on the following figures, wherein:

FIG. 1 shows a configuration of a video operation history displaying apparatus 1 embodying the invention;

FIG. 2 is a view showing an interface portion 2;

FIG. 3 is a chart on which a history displaying portion 7 plots;

FIG. 4 is the chart showing a case where moving image data is reproduced from the start and is viewed to the end;

FIG. 5 is the chart showing another case where play, rewind, fast-forward, and random play are operated

FIG. 6 is a flowchart showing the operation of the video operation history displaying apparatus 1;

FIG. 7 shows a table in the history retaining portion 6 in the initial state of the operation mode;

FIG. 8 is the chart showing further another case where the operation mode is the initial state;

FIG. 9 is a display example on a moving image displaying portion 22;

FIG. 10 shows the table in the history retaining portion 6 in a case where no instruction has been given for 2.9 seconds since the initialization;

FIG. 11 is the chart 80 displayed on the history displaying portion 7;

FIG. 12 shows the table in the history retaining portion 6 in a case where 9 seconds has passed since the play started;

FIG. 13 is the chart displayed on the history displaying portion 7;

FIG. 14 shows the table in the history retaining portion 6;

FIG. 15 is the chart displayed on the history displaying portion 7;

FIG. 16 shows the table in the history retaining portion 6;

FIG. 17 is the chart displayed on the history displaying portion 7;

FIG. 18 shows the table in the history retaining portion 6;

FIG. 19 is the chart displayed on the history displaying portion 7;

FIG. 20 shows the table in the history retaining portion 6;

FIG. 21 is the chart displayed on the history displaying portion 7;

FIG. 22 is a completed chart 80;

FIG. 23 is a view illustrating a first variation;

FIG. 24 is a view illustrating a second variation;

FIG. 25 is a view illustrating a third variation;

FIG. 26 is a view illustrating a fourth variation;

FIG. 27 is the chart displayed on the history displaying portion 7; and

FIG. 28 is a view illustrating a fifth variation.

### DESCRIPTION OF THE EMBODIMENTS

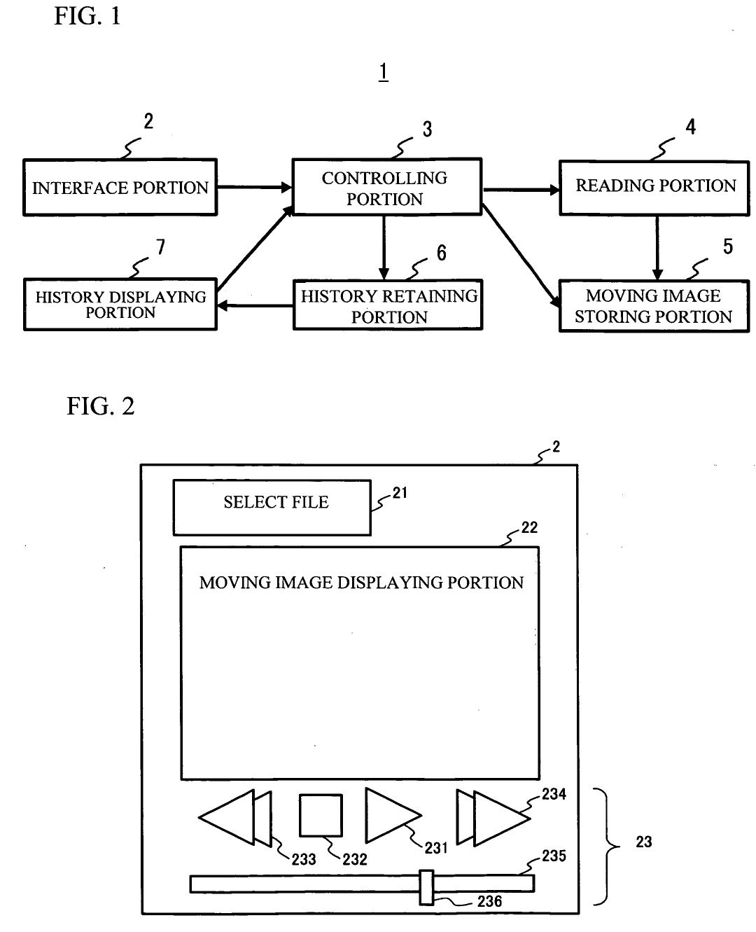

A description will now be given, with reference to the accompanying drawings, of embodiments of the present invention. FIG. 1 shows a configuration of a video operation history displaying apparatus 1 embodying the invention. Referring to FIG. 1, the video operation history displaying apparatus 1 includes an interface portion 2, a controlling portion 3, a reading portion 4, a moving image storing portion 5, a history retaining portion 6, and a history displaying portion 7. The video operation history displaying apparatus 1 is used for displaying the history made by user's video operation. The user is able to understand the operation history intuitively with the use of the video operation history displaying apparatus 1.

FIG. 2 is a view showing the interface portion 2. Referring to FIG. 2, the interface portion 2 includes a file selecting button 21, a moving image displaying portion 22, an operating portion 23. The file selecting button 21 is used for selecting moving image data to be played. The moving image displaying portion 22 displays the moving image being played. The operating portion 23 is used for operating the moving image data. The operating portion 23 is composed of a play button 231, a stop button 232, a rewind button 233, a fast-forward button 234, and a slider bar 235 for random access.

The controlling portion 3 internally includes a timer that counts an elapsed time from the start of the operation. The start of the operation denotes the time the power is switched on or the time the operating portion 23 starts to operate. The controlling portion 3 receives a signal from the operating portion 23, and controls the reading portion 4. The play procedure is arranged with the operating portion 23, and a signal for playing is applied to the controlling portion 3. Then, the controlling portion 3 instructs the reading portion 4 to read the moving image data from a current reproduction position. The controlling portion 3 initializes and activates the internal timer when accessing the moving image data for the first time. The controlling portion 3 receives the reproduction position from the reading portion 4 at the time of playing or fast-forwarding, and supplies the history retaining portion 6 with information on the elapsed time from the start of the operation shown by the timer, the reproduction position in the data, and a current operation mode, as operation history information.

The reading portion 4 is used for reproducing the moving image data according to a given operation mode, and sequentially supplies the controlling portion 3 with the reproduction position on the basis of a change in the reproduction position instructed by the controlling portion 3. Here, the reproduction position denotes a length of time from the start of the moving image data to the scene being reproduced. The reproduction position may denote the number of frames from the start. The operation mode includes play, fast-forward, rewind, stop, slow-forward, reverse play, and frame advance. The reading portion 4 stops reading the moving image data, if the operation for stop is performed. The reading portion 4 rapidly reads the moving image data backward or forward for rewinding or fast-forwarding the operation. A knob 236 of the slider bar 235 shown in FIG. 2 moves in conjunction with the current reproduction position. If a position of the knob 236 of the slider bar 235 is operated, the position thereof is applied to the controlling point 3. Then, the controlling portion 3 acquires the position of the knob 236, and instructs the reading portion 4 to move the reproduction position to another point corresponding to the moving image data. The moving image storing portion 5 stores the moving image data.

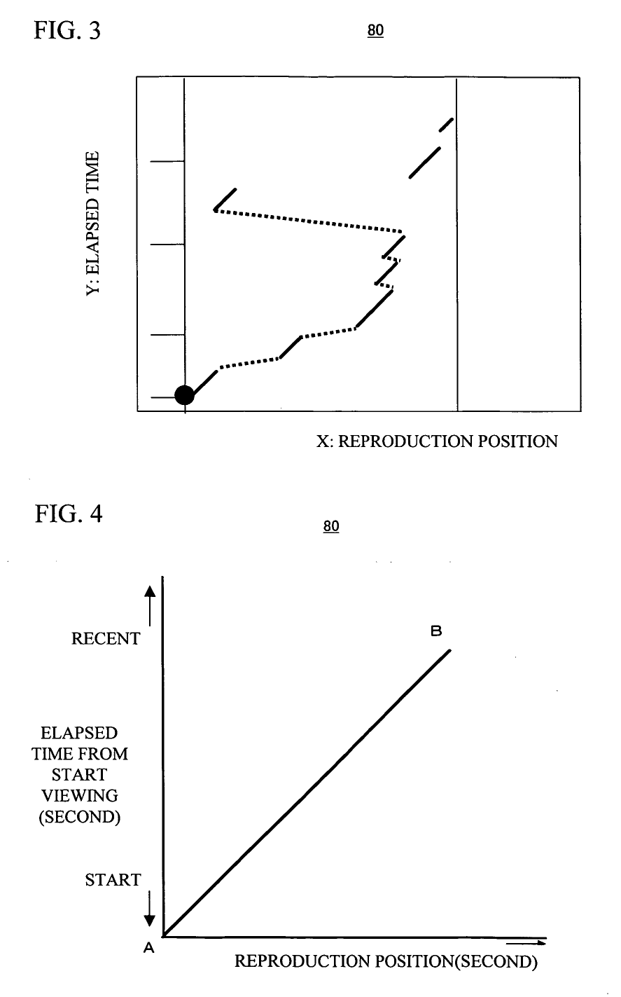

The history retaining portion 6 additionally stores a set of three items on a table. The three items include the reproduction position of the moving image data, the elapsed time from the start of operation, and the operation mode. The history displaying portion 7 plots and displays the operation history of the user on the basis of the operation history information retained in the history retaining portion 6, and then the history displaying portion 7 plots the reproduction position and the elapsed time from the start of operation on a graph with X and Y axes. FIG. 3 is a graph 80 plotted by the history displaying portion 7. The history displaying portion 7 displays an access history on the graph, that is, plots the reproduction positions on the moving image and the elapsed time from the start on the graph with X and Y axes, while the moving image is being viewed. Here, the Y-axis denotes the elapsed time from the start of operation, and the elapsed time, for example, may start from the time when the moving image starts to be viewed, or may start from the time when the moving image data is designated as the image to be reporduced.

The interface portion 2 and the history displaying portion 7 may be displayed on a computer display as a GUI (Graphical User Interface). Also, the moving image data is stored on a HDD (Hard Disc Drive) of a computer as a file.

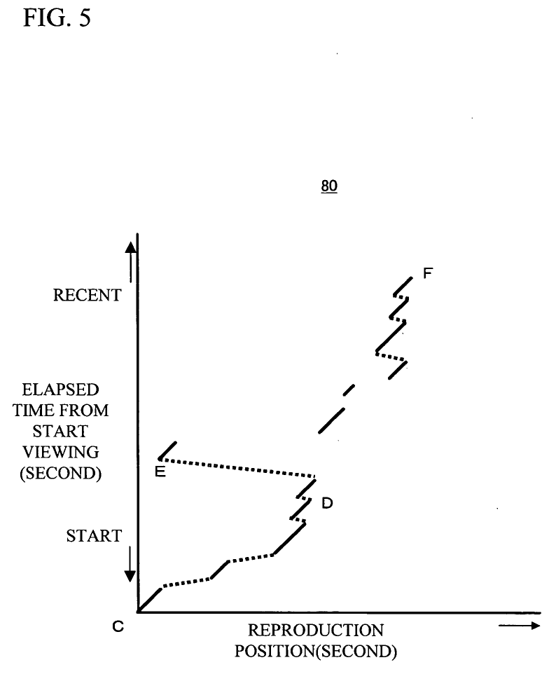

Next, a description will be given of capabilities of the history displaying portion 7. FIG. 4 is a chart 80 showing a case where the moving image data is reproduced from the start and is viewed to the end. The history displaying portion 7 monitors a state of renewal (addition) of the table retained by the history retaining portion 6, and reads an added portion from the table. The history displaying portion 7 has a graph display area for displaying the graph as a GUI, and plots the reproduction positions on the moving image and the elapsed time from the start of operation (the moving image starts to be viewed) on the graph with X and Y axes, while the moving image is being viewed. Here, the history displaying portion 7, for example, corresponds the elapsed time from the start of operation to Y, and the reproduction positions to X. FIG. 5 is the chart 80 showing another case where play, rewind, fast-forward, and random play are operated. Referring to FIG. 5, the history displaying portion 7 changes the size, color, and shape of the reproduction position to be plotted according to the type of the operation mode, and plots the operation history with different kinds of lines such as solid or dotted lines. The GUI displays the operation history of the user as a graph (on the history displaying portion 7) so that at least one of X-axis direction and Y-axis direction can be extended.

As shown in FIGS. 4 and 5, the history displaying portion 7 displays a data length of the moving image on X-axis per second as a unit. A frame may be employed as a unit. The history displaying portion 7 displays the elapsed time from the start of operation (the moving image starts to be viewed) per second. The unit may be any other unit as far as the time can be indicated. The origin of the graph is A in FIG. 4. The graph extends toward B at a start of playing. The solid lines in FIG. 5 denote playing, and the dotted lines denote rewinding or fast-forwarding. The Y-axis direction extends according to the elapsed time from the start of operation. A portion that is not plotted in the Y-axis direction indicates that the moving image data is not operated for playing or rewinding the moving image data, or is not played for a certain period of time. Another portion that is not plotted in the X-axis direction indicates that the moving image data is not played, fast-forwarded, or rewound.

The history of how the user has viewed the data can be displayed on the graph in this manner. It is therefore possible to estimate the same point or a desired point of the moving image data relying on the user's remembering of access or operation. If the access or operation has been made recently or most lately, the portion that has been plotted recently or most lately is referred to estimate the desired reproduction position in the moving image data. The Y-axis direction displays the operation history of the user as the elapsed time from the start of operation, and accordingly matches with a feeling of the elapsed time had by the user. The chart shown in FIG. 4 is an example, when the user starts playing the moving image and continues viewing to the end.

The current play position is displayed in real time on the graph shown in FIG. 5, while the moving image data is being played. This allows the user to search the scene again that has been accessed before or to skip the scene that has been seen once to the contrary. Rewinding and fast-forwarding are also shown in the graph, and it is possible to readily find a scene E that has been rewound considerably and then found, a most recent scene F after repeating rewinding and playing several times, and a scene D that has been seen some time before.

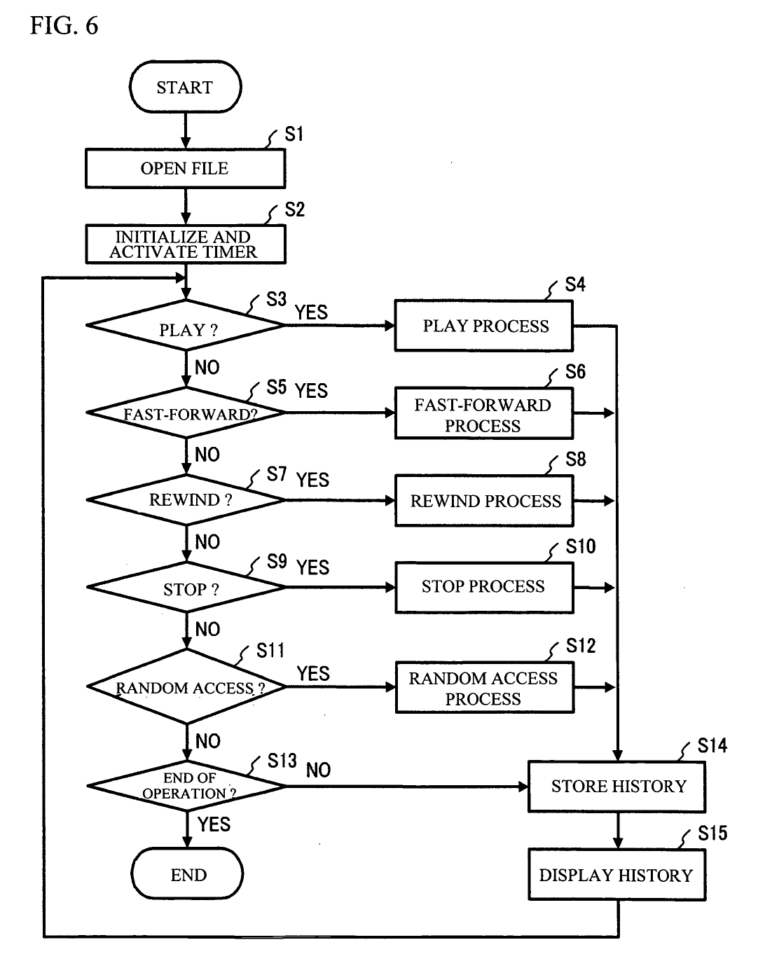

A description will now be given of the operation of the video operation history displaying apparatus 1. FIG. 6 is a flowchart showing the operation of the video operation history displaying apparatus 1. The controlling portion 3 opens a file in step S1, initializes and activates the timer in step S2. If the play button 231 is pushed in step S3, the controlling portion 3 performs a reproduction process in step S4. If the fast-forward button 234 is pushed is step S5, the controlling portion 3 performs a fast-forward process in step S6. If the rewind button 233 is pushed in step S7, the controlling portion 3 performs a rewind process is step S8. If the stop button 232 is pushed in step S9, the controlling portion 3 performs a stop process in S10. If the slider bar 235 is operated for performing the random access in step S11, the controlling portion 3 performs a random access process in step S12. If the operation is not completed in step S13, go to step S14. The history retaining portion 6 stores the history in step S14. The history displaying portion 7 displays the history in step S15.

Next, a description will be given of the operation of the video operation history displaying apparatus 1 in detail. The user selects the file selecting button 21 on the user interface portion 2, and a file select dialog is displayed. A desired moving image file is selected on a file selecting dialog. The selected file and a path to the selected file are supplied to the controlling portion 3. The controlling portion 3 searches the HDD (not shown) for the selected file, and stores the aforementioned desired moving image file in the moving image storing portion 5. If the file is successfully stored in the moving image storing portion 5, the controlling portion 3 sets the timer to 0 and starts the timer. Here, assuming that the reproduction position starts 1 of a frame number, and in addition, the moving image data is composed of 10 frames per second. The elapsed time of 0, the reproduction position of 0, and an initial state of the operation mode are supplied to the history retaining portion 6. If the operation mode indicates the initial state, the history retaining portion 6 initializes the table and enters a set of the elapsed time of 0, the reproduction position of 0, and the initial state of the operation mode into the table.

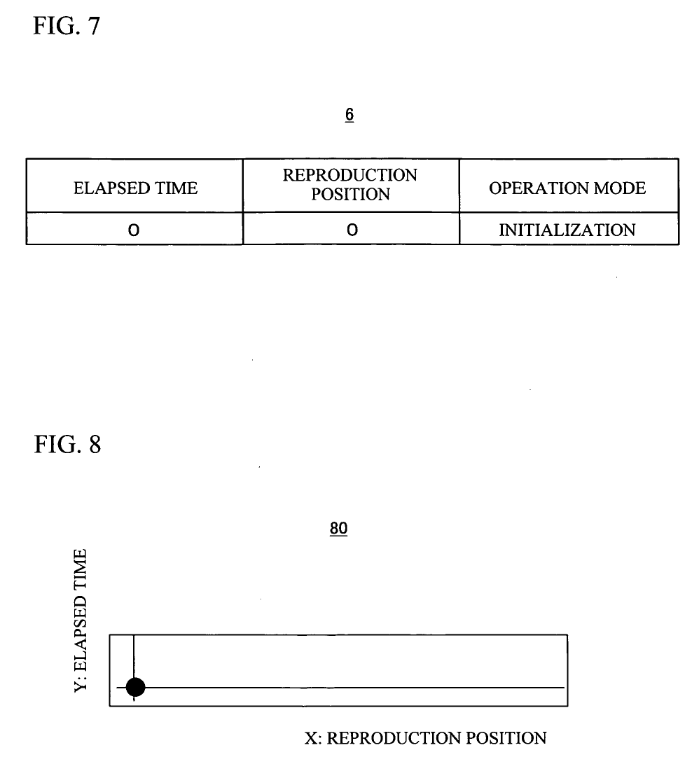

FIG. 7 shows the table in the history retaining portion 6 in the initial state of the operation mode. The history retaining portion 6 notifies that the table has been renewed together with the renewed content to the history displaying portion 7. The history displaying portion 7 receives the elapsed time of 0, the reproduction position of 0, and the operation mode, and initializes the graph area because the operation mode is the initial state, and then plots the elapsed time of 0 and the reproduction position of 0. Here, only a minimally required area may be retained in the X-axis direction.

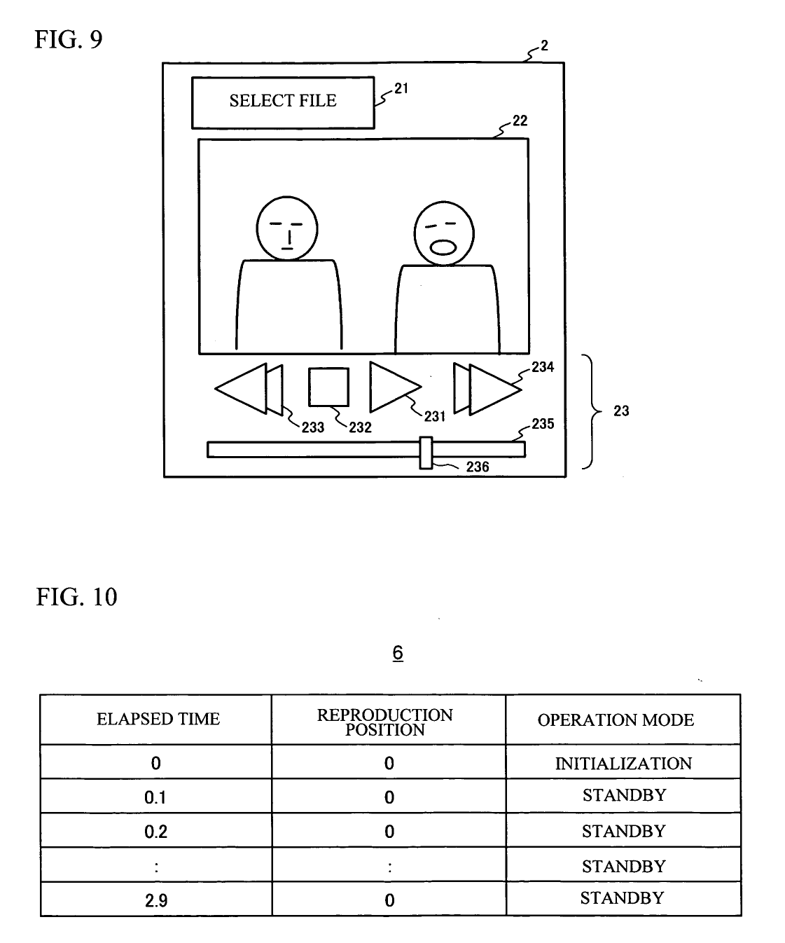

FIG. 8 is the chart 80 showing another case where the operation mode is in the initial state. Continuously, the controlling portion 3 instructs the reading portion 4 to set the reproduction position to 0. The reading portion 4 sets a point to read at 0, obtains a first piece of image information (frame) of the moving image data from the moving image storing portion 5, and applies the image information to the controlling portion 3. The controlling portion 3 supplies the image information to the interface portion 2, and displays on the moving image displaying portion 22. FIG. 9 is a display example on the moving image displaying portion 22.

After the initialization, the controlling portion 3 sets the operation mode to standby, and supplies the elapsed time, the reproduction position, and the operation mode to the history retaining portion 6 at specified time intervals. Here, 0.1 second is set for the time interval. The history retaining portion 6 adds the set of the elapsed time, the reproduction position, and the operation mode into the table. FIG. 10 shows the table in the history retaining portion 6 in a case where no instruction has been given for 2.9 seconds since the initialization. The history retaining portion 6 notifies the history displaying portion 7 that the table has been renewed together with the content of the table. The history displaying portion 7 receives the elapsed time, the reproduction position, and the operation mode.

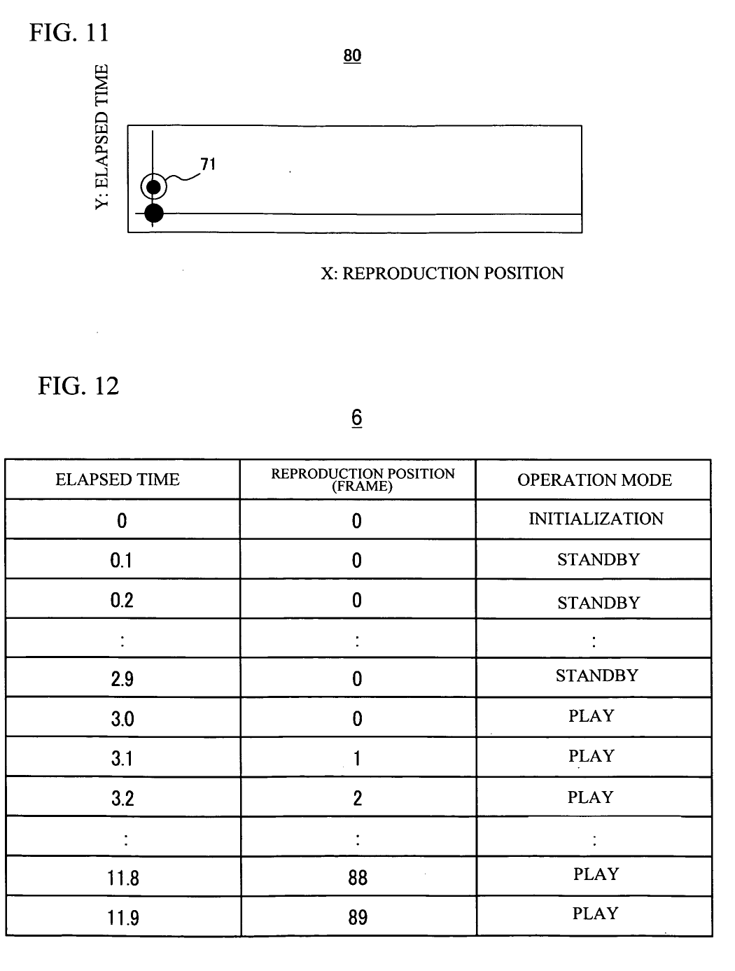

FIG. 11 is the chart 80 displayed on the history displaying portion 7. If the operation mode is the standby, the history displaying portion 7 does not plot in the graph area, as shown in FIG. 11. However, the history displaying portion 7 displays a double circle 71 as a pointer indicating the current point, and changes the position of the reproduction position with time.

If the user pushes the play button 231, the interface portion 2 notifies the controlling portion 3 that the replay operation is demanded. The controlling portion 3 instructs the reading portion 4 to acquire the moving image data from the current reproduction position. The reading portion 4 sequentially reads the moving image data from the moving image storing portion 5 while moving the reproduction position, and then supplies the controlling portion 3 with the moving image data and the reproduction position that have been read. The controlling portion 3 acquires the elapsed time with the reproduction position and the timer to be applied to the history retaining portion 6.

FIG. 12 shows the table in the history retaining portion 6 in a case where 9 seconds has passed since the play started. The controlling portion 3 supplies the moving image data to the interface portion 2 so as to sequentially display on the moving image displaying portion 22. The history retaining portion 6 supplies the elapsed time, the reproduction position, and the operation mode wherever a new piece of information is added.

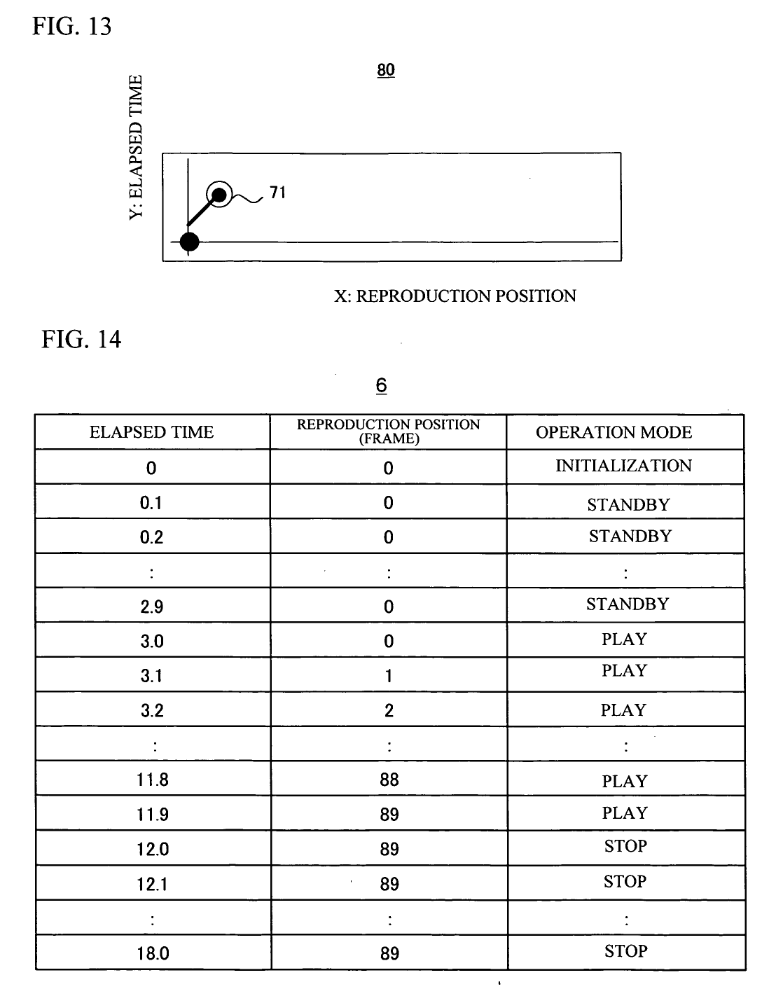

FIG. 13 is the chart 80 displayed on the history displaying portion 7. Referring to FIG. 13, the history displaying portion 7 plots the elapsed time from the operation start on Y-axis and the reproduction position on X-axis. Here, the size of the reproduction position to be plotted varies depending on the operation mode. For example, a circle having a diameter of 2 mm is plotted for indicating playing. In addition, the double circle 71 is plotted for indicating the latest point as the current point.

If the user pushes the stop button 232, the interface portion 2 informs the controlling portion 3 that the stop operation is demanded. The controlling portion 3 instructs the reading portion 4 to stop acquiring the moving image data. The controlling portion 3 acquires the elapsed time with the reproduction position and the timer to be applied to the history retaining portion 6. FIG. 14 shows the table in the history retaining portion 6. The moving image stopped at the elapsed time of 12 seconds, and since then six seconds has passed in FIG. 14. The history retaining portion 6 applies the elapsed time, the reproduction position, and the operation mode to the history displaying portion 7, whenever the new piece of information is added.

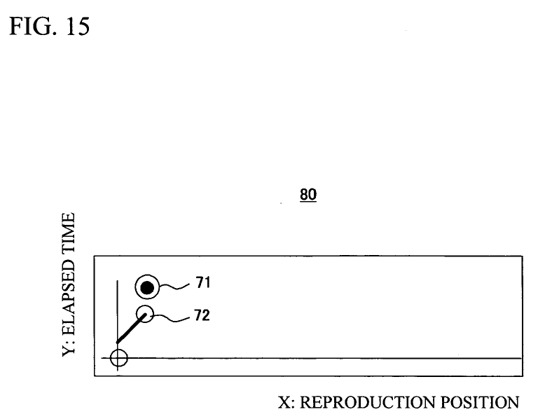

FIG. 15 is the chart 80 displayed on the history displaying portion 7. Referring to FIG. 15, the history displaying portion 7 plots the elapsed time from the start of operation on Y-axis and the reproduction position on X-axis. Here, if the operation mode is a stop state, a white circle 72 is plotted as a first stop point. If the stop state continues, nothing is plotted. The latest point is shown as the double circle 71 indicating the current point.

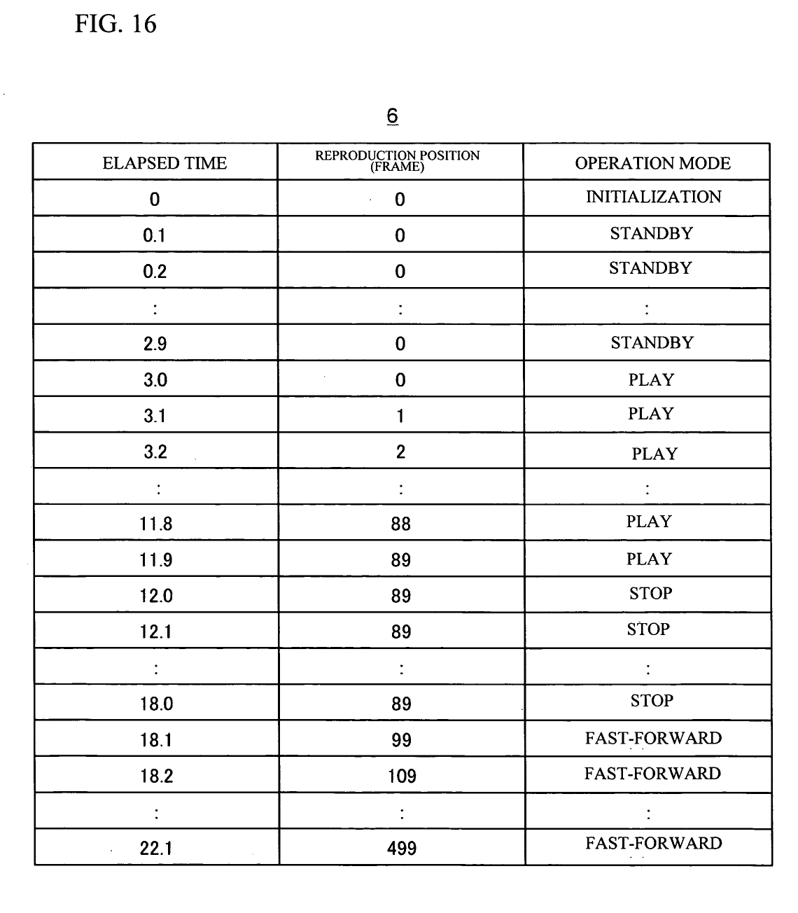

If the user pushes the fast-forward button 234, the operating portion 23 notifies the controlling portion 3 that the fast-forward operation is demanded. The controlling portion 3 instructs the reading portion 4 to acquire the moving image data from the current reproduction position. Here, some frames are skipped. For example, one frame is read from among every 10 frames. The controlling portion 3 acquires the elapsed time from the reproduction position and the timer, and applies to the history retaining portion 6. FIG. 16 shows the table in the history retaining portion 6. The history retaining portion 6 supplies the elapsed time, the reproduction position, and the operation mode to the history displaying portion 7, whenever the new piece of information is added.

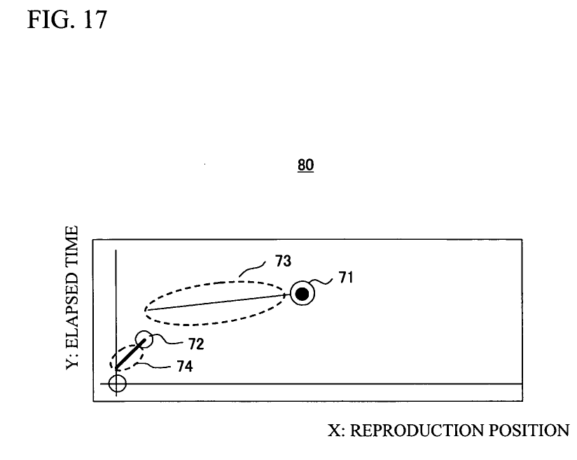

FIG. 17 is the chart 80 displayed on the history displaying portion 7. Referring to FIG. 17, the history displaying portion 7 plots the elapsed time from the operation start on Y-axis and the reproduction position on X-axis. Here, the size of the reproduction position to be plotted varies depending on the operation mode. A circle having a diameter of 1 mm is plotted for indicating fast-forwarding and rewinding. A portion surrounded by a reference numeral 73 is plotted by a circle with a diameter of 2 mm. The fast-forward operation is performed while the fast-forward button 234 is being pushed. After the fast-forward button 234 is stopped pushing, the operation mode immediately before fast-forwarding is to be performed again. That is to say, the moving image is being played, and the fast-forward button 234 is pushed for a while and released, and then the moving image is played again. The moving image is stopped, and the fast-forward button 234 is pushed for a while and released, and then the moving image is stopped again.

If the user pushes the rewind button 233, the interface portion 2 notifies the controlling portion 3 that the rewind operation is demanded. The controlling portion 3 instructs the reading portion 4 to go back from the current reproduction position and acquire the moving image data. Here, some frames are skipped. For example, one frame is read from among every 10 frames. The controlling portion 3 acquires the elapsed time from the reproduction position and the timer, and applies to the history retaining portion 6.

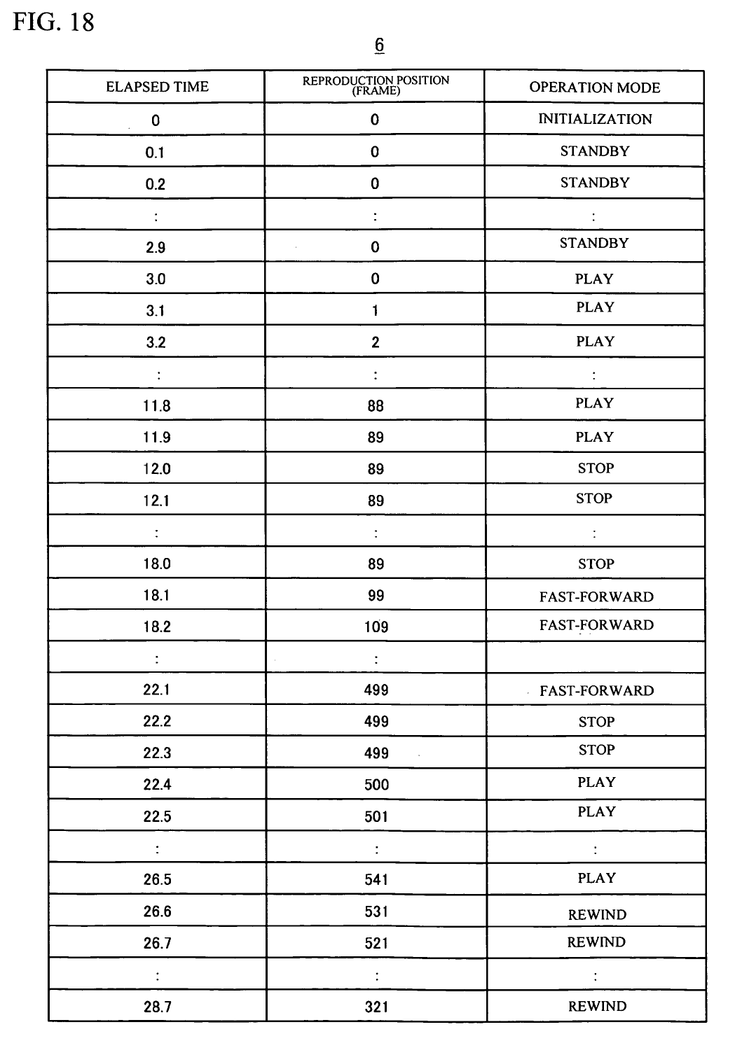

FIG. 18 shows the table in the history retaining portion 6. The rewind operation is performed while the rewind button 233 is being pushed. After the rewind button 233 is stopped pushing, the operation mode immediately before rewinding is to be performed again. That is to say, the moving image is being played, and the rewind button 233 is pushed for a while and released, and then the moving image is played again. The moving image is stopped, and the rewind button 233 is pushed for a while and released, and then the moving image is stopped again. The history retaining portion 6 applies the elapsed time, the reproduction position, and the operation mode to the history displaying portion 7, whenever the new piece of information is added.

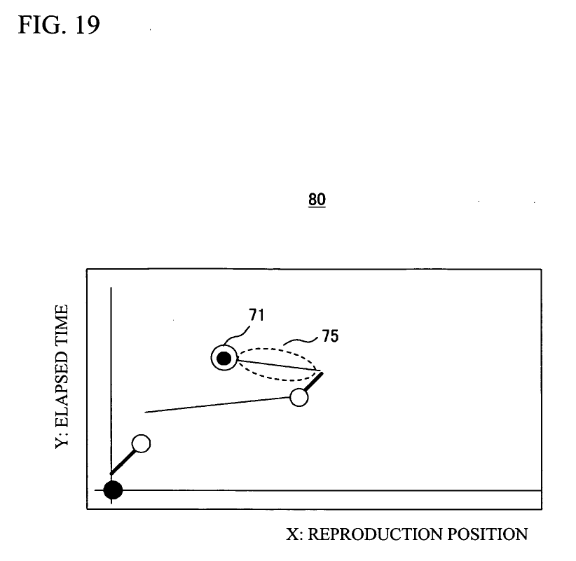

FIG. 19 is chart 80 displayed on the history displaying portion 7. Referring to FIG. 19, the history displaying portion 7 plots the elapsed time from the operation start on Y-axis and the reproduction position on X-axis. Here, the size of the reproduction position to be plotted varies depending on the operation mode. A circle with a diameter of 1 mm, as indicated by the reference numeral 75, is plotted for indicating fast-forwarding and rewinding.

The knob 236 of the slider bar 235 for random access is operated and moved (dragged), the interface portion 2 notifies the controlling portion 3 that the knob is being operated as the operation mode. The controlling portion 3 instructs the reading portion 4 to stop reading. The controlling portion 3 supplies the elapsed time, the reproduction position, and the knob operation as the operation mode to the history retaining portion 6. The history retaining portion 6 adds the set of the elapsed time, the reproduction position, and the operation mode to the table. The history displaying portion 7 receives the renewed content, and renews the graph area. If the operation mode is the knob operation, nothing is plotted and only the pointer 71 of the double circle is moved.

After the knob 236 finishes moving, the interface portion 2 notifies the controlling portion 3 of the random access as the operation mode. The controlling portion 3 also notifies the position of the knob 236. The position of the knob 236 indicates a distance from the left end, and assuming that there is a distance of 100 from the left end to the right end. Here, suppose that the knob 236 is moved to a position of 70. The controlling portion 3 instructs the reading portion 4 to move the moving image data from the current reproduction position to the position of 70. The reading portion 4 calculates the frame existing on the position of 70 percent from the start of all the frame number. Here, assuming that there are provided 1,000 frames. The position of 70 percent from the start is a frame of 700. Then, the reproduction position is moved to the frame of 700. Whether the frame of 700 is to be played or stopped takes over the same operation before the knob 236 is moved. Here, the operation mode before the knob 236 is moved is the play mode, and accordingly the frame of 700 starts to be operated. The controlling portion 3 acquires the elapsed time from the reproduction position and the timer to apply to the history retaining portion 6.

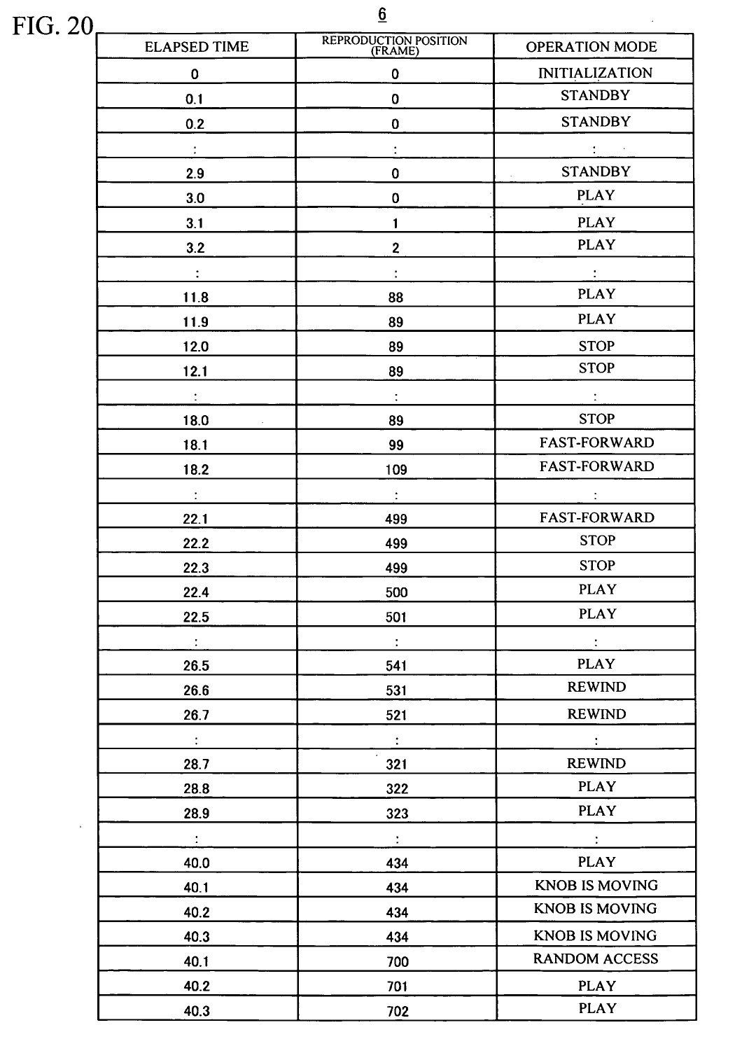

FIG. 20 shows the table in the history retaining portion 6. The history retaining portion 6 applies the elapsed time, the reproduction position, and the operation mode to notifies the history displaying portion 7, whenever the new piece of information is added.

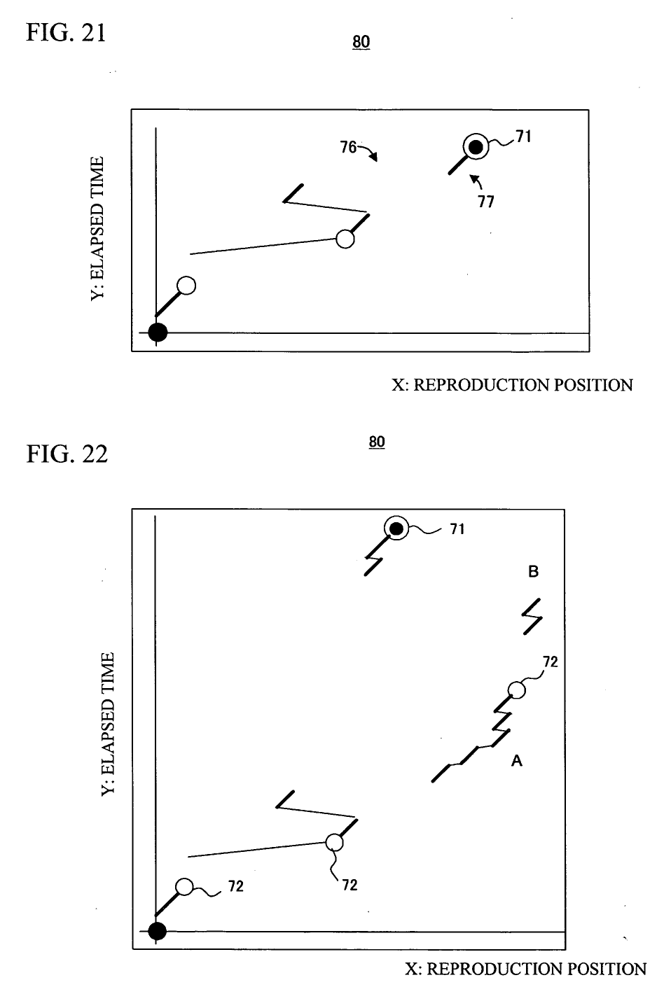

FIG. 21 is the chart 80 displayed on the history displaying portion 7. Referring to FIG. 21, the history displaying portion 7 does not plot anything particularly as indicated by a reference numeral 76, if the operation mode is the random access. The pointer 71 of the double circle, which indicates the current reproduction position, is just moved to the current point. If the play mode continues, the dots having diameter of 2 mm are plotted as indicated by a reference numeral 77. Consequently, playing, rewinding, fast-forwarding, and random access are repeated, and a graph shown in FIG. 22 is completed.

FIG. 22 is the chart 80 that has been completed. Here, assuming that the user likes to watch some portions once again in the latter half of the data that have been watched before. If the aforementioned portions are relatively previous ones, the user clicks around B in FIG. 22. The user may click around A, if the portions were watched before the period of stopping for awhile. The user clicks around B, and the history displaying portion 7 detects the position that has been clicked, acquires the X-coordinate (frame number) thereof, and applies to the controlling portion 3. The controlling portion 3 instructs the reading portion 4 to set the frame number corresponding to the X-coordinate to the reproduction position. The reading portion 4 sets the reproduction position to the designated frame, and supplies the image of the frame to the controlling portion 3. The controlling portion 3 supplies the image to the interface portion 2, and then the image is displayed. Whether the image is to be played or stopped takes over the same operation before the graph is clicked. The operation to be continued is also recorded in the operation history and shown in the graph.

The operation history is shown as a graph indicating the elapsed time from the start and the reproduction position in the above-mentioned manner. This makes it possible to access the scene that has been watched readily again with clues in what point and when the scene has been watched. Moreover, the graph is displayed differently depending on the operation mode. This also serves as a clue to facilitate the access to the desired scene. For example, if the user likes to watch the scene that was played immediately after rewinding for a long time, just find a thin line extending toward a direction of ten o'clock, which is slightly slanted upwardly from the direction of nine o'clock. The table stored in the history retaining portion 6 may have variations in retaining the data.

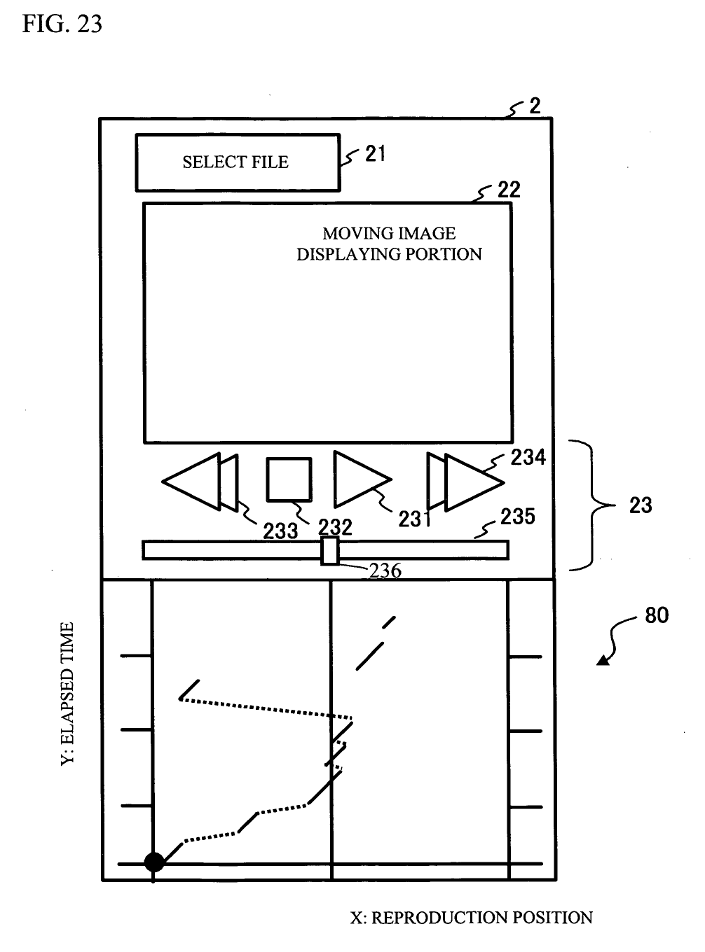

In addition, the above-mentioned embodiment may have variations as follows. FIG. 23 is a view illustrating a first variation. The operating portion 23 having the slider bar 235 and the graph 80 displayed on the history displaying portion 7 are adjacently arranged in Y-axis direction (up and down), the length of the slider bar 235 is made equal to that of X-axis of the graph 80 that displays the operation history of the user, and the position of the knob 236 of the slider bar 235 is arranged as a straight line parallel to Y-axis of the graph 80. This makes it possible to move to the desired scene while looking at the aforementioned straight line in parallel with Y-axis. In this manner, it is possible to give instructions to retrieve the data with the use of the knob 236 of the slider bar 235, while watching the operation history of the user shown by the history displaying portion 7.

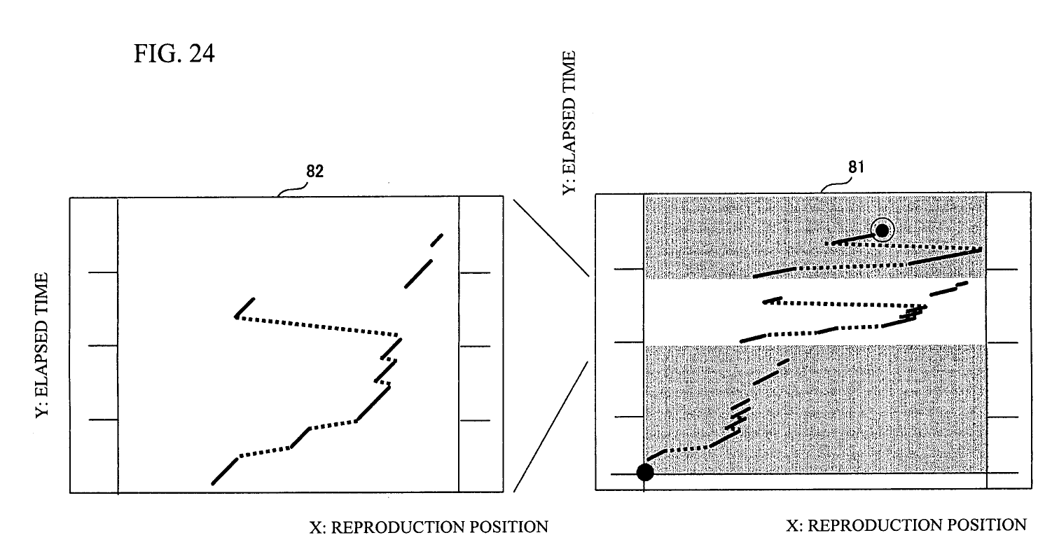

FIG. 24 is a view illustrating a second variation. As the operation period of time becomes longer, the graph extends longitudinally and may not be viewed readily. In this case, the history displaying portion 7 displays a wide-range graph 81 of a graph 82 in which the reproduction position of the data and the elapsed time from the start are plotted. In other words, the graph 81 that can display a wider range is displayed together with the normal graph. A white background in the wide-range graph 81 is the range shown in the normal graph. By clicking on Y-axis, the graph around the clicked point can be displayed on the normal graph. By selecting an arbitrary point in the wide-range graph 81, the moving image can be played corresponding to the point, as in the normal graph.

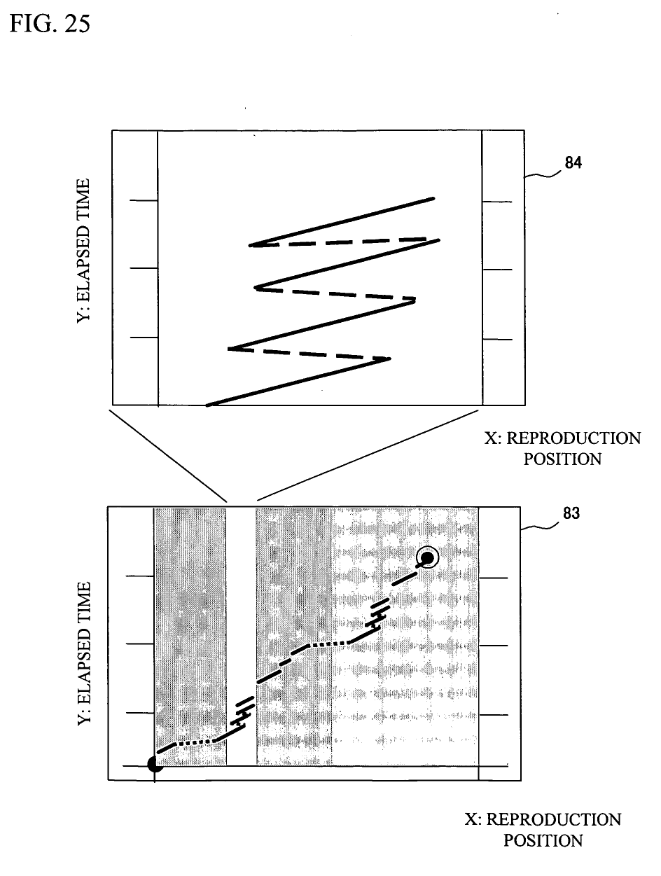

FIG. 25 is a view illustrating a third variation. The history displaying portion 7 displays another wide-range graph 83 of a graph 84 in which the reproduction position of the data and the elapsed time from the start are plotted. The history displaying portion 7 also displays a partially enlarged view of the operation history of the user. In this manner, if the moving image data is long, the graph 83 that can display a wider range is displayed together with the graph 84 that can display an enlarged view of a focused point. In this manner, the whole graph and a detail in the graph can be viewed together.

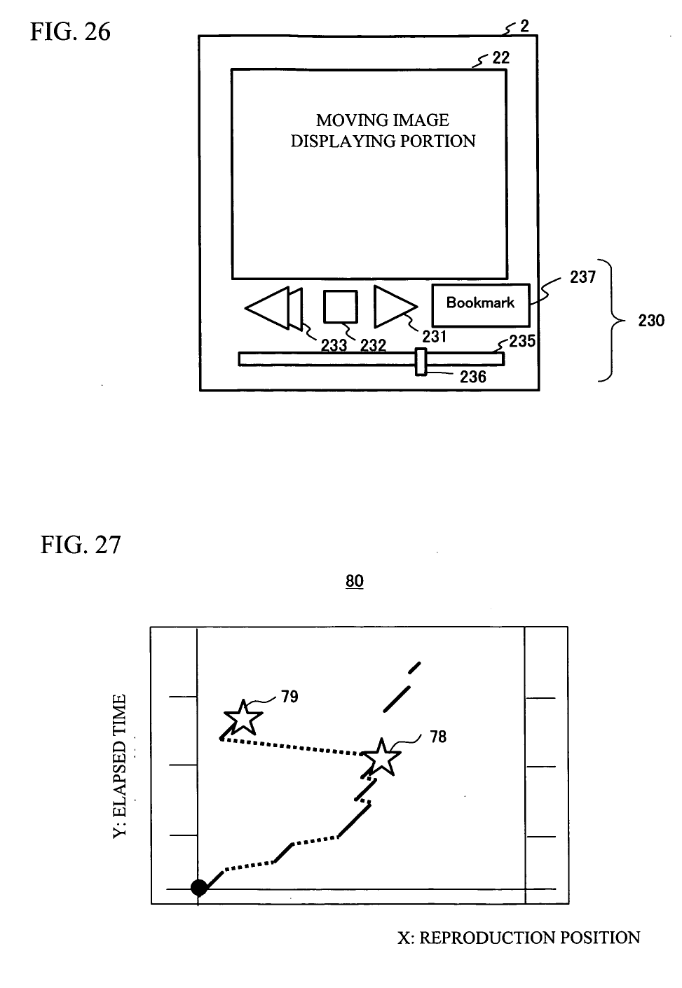

FIG. 26 is a view illustrating a fourth variation. In the fourth variation, the user is able to append a bookmark arbitrarily. The interface portion 2 provides a button 237 (appending portion) for book mark setting in an operation portion 230 in order to append the bookmark as a mark in the operation history of the user, in which the reproduction position of the data and the elapsed time from the start of operation are plotted. The button 237 is pushed and the controlling portion 3 is instructed to append a bookmark. The controlling portion 3 supplies the history retaining portion 6 that the bookmark is given to the elapsed time, the reproduction position, and the operation mode. The history retaining portion 6 adds the aforementioned information into the table.

FIG. 27 is the chart 80 displayed on the history displaying portion 7. Referring to FIG. 27, the history displaying portion 7 plots star signs 78 and 79 in the graph area on the basis of the information added to the history retaining portion 6. This makes it possible to explicitly record the reproduction position that may be viewed later once again.

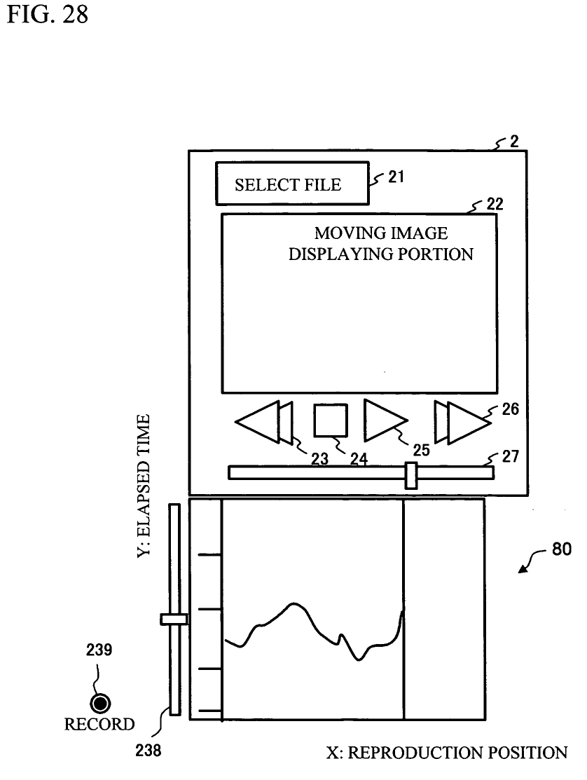

FIG. 28 is a view illustrating a fifth variation. The user is able to input an arbitrary value on Y-axis. For example, there is provided a user input slider bar 238. The user is able to change the value of the user input slider bar 238 at random while watching the moving image and reflect the value in Y-axis. A record check box 239 is checked to reflect the value on the user input slider bar 238 onto Y-axis. After the moving image is rewound and the graph is already plotted, the graph is renewed with the new value. If the moving image is simply reviewed, uncheck the record check box 239. In this case, the value of the user input slider bar 238 is not reflected on the graph.

In this manner, the user is able to move the user input slider bar 238 to continuously input the values of the scenes in which the user feels interested or important. The values are reflected in real time. It is therefore possible to determine the value of the current reproduction position referring to the value that has been appended. For example, a bigger value is given to the current reproduction position because it is more interesting than the last one. This graph allows the user to understand the interesting or important point immediately if the moving image is watched next time. Then, the play can be started by selecting the point.

Displayed mark or display method on the graph is varied depending on the operation. Other display methods may be employed other than the abovementioned ones. The X-coordinate and the Y-coordinate may be exchanged. The graph may be displayed in another quadrant other than the first one. Additionally, the present invention is applicable to not only the moving image data but also the voice data. Further, by storing a set of the history graph and the person who has watched the moving image data, the user is able to access the reproduction position, referring to the point in which the person who has watched before was interested.

An information analysis method of the present invention is realized with a CPU (Central Processing Unit), ROM (Read Only Memory), RAM (Random Access Memory), and the like, by installing a program from a portable memory device or a storage device such as a hard disc device, CD-ROM, DVD, or a flexible disc or downloading the program through a communications line. Then the steps of program are executed as the CPU operates the program. The program makes the CPU (computer) perform counting an elapsed time from a start of an operation when data is reproduced according to a given operation mode, retaining information on a reproduction position in the data reproduced by the reproducing portion, an elapsed time from the start of the operation, and a current operation mode, as operation history information, displaying an operation history of a user on the basis of the operation history information, and receiving an instruction to search the data from a user watching the operation history.

The reading portion 4 corresponds to a reproducing portion. The controlling portion 3 corresponds to a timer. The history retaining portion 6 corresponds to a retaining portion. The history displaying portion 7 corresponds to a displaying portion. The knob 236 of the slider bar 235 corresponds to an instructing portion.

It is therefore possible to access the scene that has been watched readily again with clues in what point and when the scene has been watched. This enables the user to search the scene again that has been accessed before or to skip the scene that has been seen once to the contrary. The user is able to understand the operation history intuitively. The reproduction positions and the elapsed time are plotted on a view, also known as a graph. The timer may start counting the elapsed time since the data is instructed to be reproduced. Then, the displaying portion plots the reproduction positions of the data and the elapsed time since the data is designated, on a graph having the X- and Y-axes. The reproducing portion reproduces the data in a broad sense such as normal play, fast-forward, rewind, and the like.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2005-068254 filed on Mar. 10, 2005 including specification, claims, drawings, and abstract is incorporated herein by reference in its entirety.

What is claimed is:

1. An operation history display apparatus comprising:
a reproducing portion reproducing data according to a given operation mode;
a timer counting an elapsed time from a start of an operation; and
a retaining portion retaining information on a reproduction position in the data reproduced by the reproducing portion, an elapsed time from the start of the operation, and a current operation mode, as operation history information.

2. The operation history display apparatus according to claim 1, further comprising a displaying portion plotting and displaying an operation history of a user on the basis of the operation history information retained in the retaining portion.

3. The operation history display apparatus according to claim 1, further comprising
a displaying portion plotting and displaying an operation history of a user on the basis of the operation history information retained in the retaining portion; and
an instructing portion designating a position in the operation history and giving an instruction to search the data for a designated position.

4. The operation history display apparatus according to claim 2, wherein the displaying portion changes at least one of a size, color, and shape of the reproduction position to be plotted, according to a type of the operation mode.

5. The operation history display apparatus according to claim 1, wherein the operation mode is at least one of normal play, fast-forward, rewind, stop, slow-forward, reverse play, and frame advance.

6. The operation history display apparatus according to claim 2, wherein the displaying portion sets a Y-axis to the elapsed time from the start of the operation to display the operation history of the user.

7. The operation history display apparatus according to claim 2, wherein the displaying portion plots the operation history of the user by using different kinds of lines.

8. The operation history display apparatus according to claim 2, wherein the operation history of the user is displayed so that at least one of an X-axis direction and a Y-axis direction can be extended.

9. The operation history display apparatus according to claim 2, wherein the displaying portion displays a wide-range graph in which the reproduction position of the data and the elapsed time from the start of the operation are plotted.

10. The operation history display apparatus according to claim 2, wherein the displaying portion displays a partially enlarged view of the operation history of the user.

11. The operation history display apparatus according to claim 1, further comprising an interface portion having an appending portion appending a mark on a graph in which the reproduction position of the data and the elapsed time from the start of the operation are plotted.

12. The operation history display apparatus according to claim 2, further comprising an interface portion providing a portion for appending a mark in the operation history of the user,
wherein the retaining portion retains information on the mark appended to be associated with the operation history information.

13. The operation history display apparatus according to claim 1, wherein a slider for operating the data and the operation history of the user are arranged in Y-axis direction, a length of the slider is set equal to that of X-axis of the operation history of the user, and a position of a knob of the slider is represented as a straight line parallel to the Y-axis of the graph.

14. The operation history display apparatus according to claim 1, wherein the data is at least one of moving image data and voice data.

15. An operation history display method comprising:
reproducing data according to a given operation mode;
counting an elapsed time from a start of an operation;
retaining information on a reproduction position in the data reproduced by the reproducing portion, an elapsed time from the start of the operation, and a current operation mode, as operation history information;
displaying an operation history of a user on the basis of the operation history information; and
receiving an instruction to search the data from a user watching the operation history.

16. A storage medium readable by a computer, the storage medium storing a program of instructions executable by the computer to perform a function for operation history display program, the function comprising:
counting an elapsed time from a start of an operation when data is reproduced according to a given operation mode;
retaining information on a reproduction position in the data reproduced by the reproducing portion, an elapsed time from the start of the operation, and a current operation mode, as operation history information;
displaying an operation history of a user on the basis of the operation history information; and
receiving an instruction to search the data from a user watching the operation history.
